(19) United States
(12) Patent Application Publication
(10) Pub. No.: US 2014/0188369 A1
(43) Pub. Date: Jul. 3, 2014

(54) CONTROL APPARATUS OF AN IGNITION SPARK PLUG AND ENGINE ELECTRONIC IGNITION SYSTEM HAVING OPEN SECONDARY PROTECTION

(71) Applicant: STMicroelectronics S.r.I., Agrate Brianza (MB) (IT)

(72) Inventors: GiovanniLuca TORRISI, Aci Catena / Catania (IT); CalogeroAndrea TRECARICHI, Aci Catena (CT) (IT)

(73) Assignee: STMicroelectronics S.r.I., Agrate Brianza (MB) (IT)

(21) Appl. No.: 14/097,852

(22) Filed: Dec. 5, 2013

(30) Foreign Application Priority Data
Jan. 3, 2013 (IT) MI2013A000002

(51) Int. Cl. F02P 9/00

(52) U.S. Cl. CPC F02P 9/00
USPC 701/102

(57) ABSTRACT

A control apparatus of an engine ignition spark plug includes a switch having a control terminal and an output terminal connected to an external transformer. The switch assumes a closed state for supplying energy to the transformer, and an open state for the transformer to supply energy to the spark plug. A measuring module measures a time duration where, in the open state, a voltage at the output terminal of the switch decreases from a first value to a second value. A detecting module detects an operating condition of the spark plug based on comparing the measured time duration to a time threshold, and to generate a detecting signal based on the comparing.

### FIELD OF THE INVENTION

The present invention relates to a control apparatus of an engine ignition spark plug, such as for a motor vehicle.

### BACKGROUND OF THE INVENTION

To provide an electronic ignition for internal combustion engines, such as Otto cycle (i.e., four-stroke) engines, circuits with a switch, a spark plug, and a transformer connected across the spark plug and switch may be used. Typically, the switch may be implemented by a solid-state component, such as an IGBT transistor or Darlington configuration bipolar transistors (i.e., a Darlington configuration transistor).

Electronically closing the solid-state switch using a control signal allows current to flow through the primary winding of a transformer that charges with an energy equal to L*I²/2. The variable L is the inductance value of the primary winding, and the variable I is the current flowing through it.

Once the primary winding has been charged to the desired energy necessary to generate a spark at the secondary winding, the solid-state switch is electronically opened. After opening the solid-state switch, the current at the primary winding is abruptly interrupted and the energy, previously stored in it, is released as a voltage pulse across the primary winding. Such a pulse may be equal to 200-400 Volts, for example.

The voltage variation across the primary winding generates an electric field, and therefore, there is a mutual inductance coupling with the secondary winding. The secondary winding is sized, for example, with a turns ratio N2/N1 of about 100. A voltage is generated in the secondary winding, which is about 100 times the voltage in the primary winding, and is about 20-40 kV. This voltage is applied to the spark plug connected to the secondary winding of the transformer. This is sufficient to generate a spark in the combustion chamber in which the spark is received.

If a plug is not present or does not perfectly operate when the solid-state switch is opened, a condition known as an open secondary occurs. The energy stored in the primary of the transformer cannot be usefully transferred to the transformer secondary. Consequently, the energy is dissipated in the primary winding. More particularly, the energy will be dissipated by the solid-state component operating as a switch.

This condition is particularly demanding for a solid-state component when the device operates in a current limiting condition. The current is a maximum current allowed by the ignition circuit configuration, and therefore, the energy to be dissipated takes a maximum value.

In addition, the problem of power dissipation from the solid-state switch is further exacerbated because the marketplace requires devices which are increasingly smaller in terms of their silicon and package areas. These factors reduce the thermal capacities instrumental to the dissipation process in case of an open secondary.

In light of what has been described beforehand regarding the thermal dissipation problems in the open secondary condition, this condition is a potential cause of breakdown of the electronic ignition circuit. The breakdown may be the solid-state power element acting as the switch, along with consequential damages of the portions which the electronic ignition circuit is connected to, such as the coil and the electronic unit, for example.

U.S. Published Patent Application No. 2004/0200463 describes a device for the ignition of internal combustion engines having, among other things, an IGBT transistor acting as a switch, a current limiting circuit, and an anomalies detecting circuit capable of detecting an anomaly in the ignition signal generated by an electronic control unit.

### SUMMARY OF THE INVENTION

In view of the foregoing background, an object of the present invention is to reduce thermal dissipation problems in an open secondary condition of an electronic ignition circuit.

This and other objects, features and advantages in accordance with the present invention are provided by a control apparatus for an engine ignition spark plug comprising a switch comprising a control terminal and an output terminal both to be connected to an external transformer, with the switch having a closed state to supply a voltage to the transformer and an open state to release the voltage from the transformer to the spark plug. A measuring module may measure in the open state a time duration of a voltage at the output terminal decreasing from a first value to a second value. A detecting module may detects an operating condition of the spark plug based on comparing the measured time duration to a time threshold, and to generate a detecting signal based on the comparing.

Another aspect is directed to a method for operating a control apparatus for an engine ignition spark plug, wherein the control apparatus comprises a switch comprising a control terminal and an output terminal both connected to a transformer. The method comprises operating the switch in a closed state to supply a voltage to the transformer and in an open state to release the voltage from the transformer to the spark plug. The method may further comprise measuring in the open state a time duration of a voltage at the output terminal decreasing from a first value to a second value. An operating condition of the spark plug may be detected based on comparing the measured time duration to a time threshold, a detecting signal may be generated based on the comparing.

### BRIEF DESCRIPTION OF THE DRAWINGS

Referring to the attached drawings, non-limiting embodiments will be described for a better understanding of the invention, wherein:

FIG. 1 schematically shows an electronic ignition system of an internal combustion engine comprising a spark plug, a solid-state switch, and an control apparatus of the switch in accordance with the present invention;

FIG. 2 schematically shows a comparing module used in the control apparatus shown in FIG. 1;

FIG. 3 schematically shows a trend of signals and electrical quantities characterizing operation of the ignition system in FIG. 1;

FIG. 4a shows a first curve A relative to a trend of an electrical current in a solid-state switch occurring in an electronic ignition system of the prior art during an open secondary event, and a second curve B relative to a trend of the collector current in the solid-state switch occurring in the ignition system of FIG. 1 in the same operating conditions;

FIG. 4b shows a third curve C and a fourth curve D both referring to a trend as a function of time and temperature in the solid-state switch junction for corresponding currents having the trend of curves A and B, respectively;

FIG. 5 shows the corresponding electrical energy to be dissipated for different values of the limiting current which the solid-state switch is subjected to as shown in FIG. 1.

### DETAILED DESCRIPTION OF THE PREFERRED EMBODIMENTS

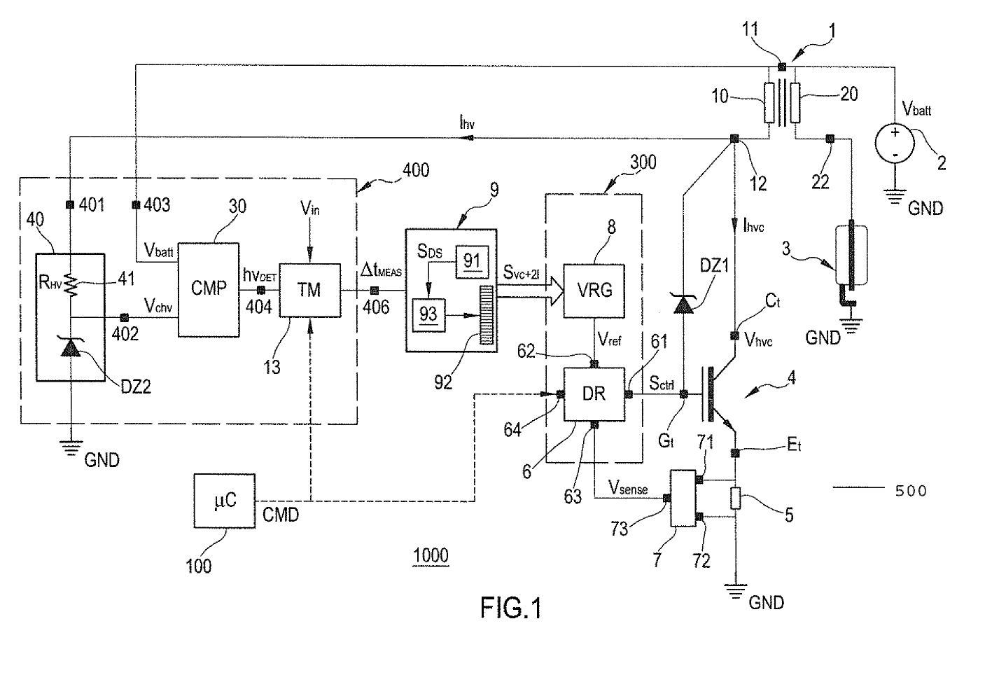

FIG. 1 shows a particular embodiment of an electronic ignition system 1000 of an internal combustion engine, such as an Otto cycle (i.e., four-stroke) engine, which may be used in motor vehicles, for example. Electronic ignition system 1000 comprises a control apparatus 500, an electrical transformer 1, a spark plug 3, and is supplied by an electrical voltage generator 2, such as a battery.

The electrical transformer 1 is provided with a primary winding 10 located between the polarizing terminal 11 and a primary terminal 12, and a secondary winding 20 located between a polarizing terminal 11 and a secondary terminal 22.

The polarizing terminal 11 is connected to a positive pole of the battery 2 generating a supplying voltage V_{batt}. A negative pole of the battery 2 is instead connected to a ground terminal gnd. Connected to the secondary terminal 22 is instead a central electrode of the spark plug 3 having a ground electrode connected to the ground terminal gnd. The electrical transformer 1 is adapted to store electrical energy in the primary winding 10 for discharging it in the secondary winding 20 to enable the spark plug 3 to generate an electrical spark.

The control apparatus 500 comprises a solid-state switch 4 having a control terminal Gₜ and an output terminal Cₜ connected to the electrical transformer 1. The solid-state switch 4 is configured to have a closing state to supply energy to the electrical transformer 1, and an opening state to release energy to the spark plug.

In the following, the solid-state switch 4 will also be referred to simply as a switch. The switch includes, for example, an IGBT (insulated gate bipolar transistor) type power transistor as shown in FIG. 1. The switch may also include Darlington configured bipolar transistors, or Trilinton configured bipolar transistors (i.e., three stages).

The switch 4 is configured to drive electrical current flowing through the primary winding 10. More specifically, the switch 4 is provided with a collector terminal Cₜ to receive a collector current I_{hvc} and supply a collector voltage V_{hvc} referenced to the ground terminal gnd, and is connected to the primary terminal 12 of the electrical transformer 1. Further, the switch 4 is provided with an emitter terminal Eₜ connected, for example, through a first terminal of a sensing resistor 5 (having resistance Rₛₑₙₛₑ) with a corresponding second terminal connected to the ground terminal gnd.

The switch 4 is also provided with a gate terminal Gₜ to receive a first driving signal S_{ctrl} by which the collector current I_{hvc} control is performed. Further, the control apparatus 500 is provided with a measuring module 400 configured to measure a time interval value Δt_{MEAS} during which, in the switch 4 open state, a collector voltage V_{hvc} decreases from a first maximum value to a second value.

According to a particular example, the measuring module 400 comprises a voltage detecting module 40, a comparing module 30, and a time detecting module 13. The voltage detecting module 40 is provided with a corresponding first input terminal 401 connected to the collector terminal Cₜ of switch 4, and is configured to detect the collector voltage V_{hvc} and supply this voltage to a first output terminal 402 as a reading signal Vᵣₕᵥ.

For example, the voltage detecting module 40 comprises a detecting resistor 41 having a resistance R_{HV} connected across the first input terminal 401 and the first output terminal 402. Moreover, a Zener diode DZ2 is connected across the first output terminal 402 and the ground terminal gnd.

The comparing module 30 is connected to the first output terminal 402 for receiving the reading signal Vᵣₕᵥ, and is provided with a second input terminal 403 for receiving the supplying voltage V_{batt}, and with a second output terminal 404 for a comparing signal hv_{DET}. The illustrated comparing signal hv_{DET} is a square-shaped wave. The comparing module 30 is configured to compare the reading signal Vᵣₕᵥ with at least one threshold voltage depending on the supplying voltage V_{batt}.

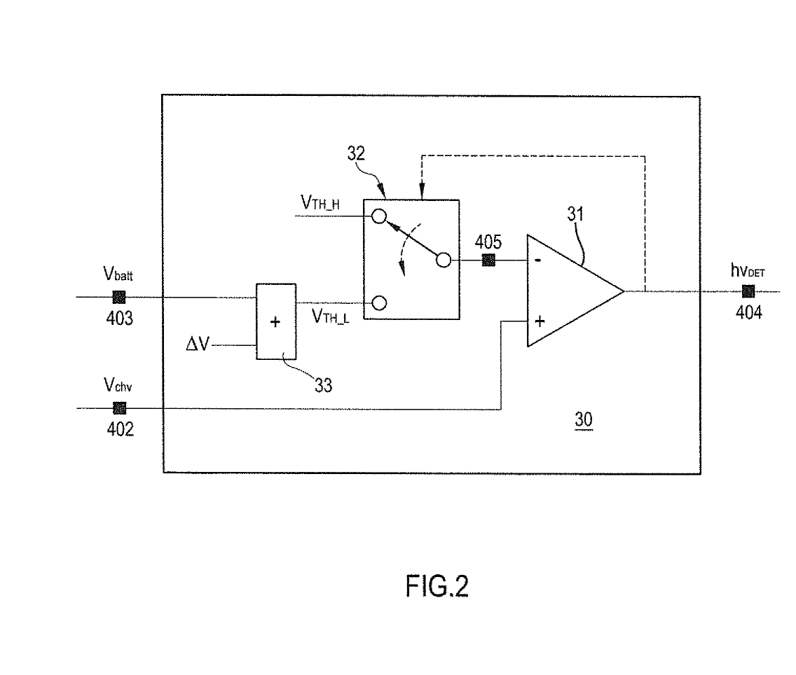

FIG. 2 shows a particular embodiment of the comparing module 30 comprising a comparator 31 provided with an inverting input −, a non-inverting input +, and a comparing output corresponding to the second output terminal 404 to make available the comparing signal hv_{DET}.

The inverting input of the comparator 31 is connected to a third output terminal 405 of a selection module 32 that is driven by the comparing signal hv_{DET}. The selection module 32 is capable of switching between a first configuration wherein it makes available at the third output terminal 405 a first threshold voltage VTH_H, and a second configuration wherein it makes available at the third output terminal 405 a second threshold voltage VTH_L. The second threshold voltage VTH_L is available at the output of a summing module 33 configured to sum an additional positive voltage ΔV to the supplying voltage V_{batt}, and therefore generate the second threshold voltage VTH_L.

Referring again to FIG. 1, the measuring module 400 is also provided with a time detecting module 13 having an input connected to the second output terminal 404 for receiving the comparing signal hv_{DET}. More particularly, the time detecting module 13 is configured to measure the time interval value Δt_{MEAS} of the interval elapsing between a leading edge and the following trailing edge of the comparing signal hv_{DET}, and supply a corresponding signal representative of such a value at a fourth output terminal 406. The corresponding signal may be, for example, a digital signal.

The time detecting module 13 is further provided with another input terminal for receiving a driving signal CMD adapted to switch it on and off. Particularly, the time detecting module 13 is switched on at the trailing edge of the driving signal CMD, and is switched off at the end of the time interval AΔ_{MEAS} measurement (trailing edge of the comparing signal hv_{DET}). The time detecting module 13 is implemented, for example, by a counter and a clock.

The control apparatus 500 further comprises a detecting module 9 configured to detect anomalies in the spark plug 3 operation. This is based on the time duration value Δt_{MEAS} as measured. The control apparatus 500 generates a detecting signal SV_{ctrl}, such as for example, a digital signal.

These spark plug anomalies correspond to “open secondary” situations, and therefore, to those situations wherein the spark plug 3 is not capable of generating the desired electrical spark, after one or more ignition attempts. The “open secondary” condition verifies when the spark plug 3 is not present, is damaged or is not correctly connected to the ignition system 1000.

More specifically, the detecting module 9 is configured to detect an anomaly in the spark plug 3 when the above-mentioned time duration Δt_{MEAS} is less than a time threshold Tₜₕ. Further, the detecting module 9 is configured to detect a regular operating condition in the spark plug 3 when the time duration Δt_{MEAS} is greater than the time threshold Tₜₕ. Under the regular operating condition, the spark plug 3 strikes the desired electrical spark to ignite the engine.

It is observed that, according to a first embodiment of the detecting module 9, the detecting signal SV_{ctrl} is such to indicate the presence of an anomaly when it detects a spark absence condition for a number Ns of times (wherein number Ns is greater than or equal to 1). If the spark absence is detected for a number of times less than Ns, then the detecting signal SV_{ctrl} indicates a regularity condition.

In the following description, the spark absence condition will be indicated as a NO SPARK condition, while the spark presence condition will be indicated as a SPARK condition. According to this first embodiment, the detecting module 9 can comprise, for example, a comparing digital module 91, a decision module 93 and an incrementable register 92.

More particularly, the comparing digital module 91 is configured to compare the time duration value Δtₘₑₐₛ with the time threshold Tₜₕ and supply a further comparing signal S_{DS}, which can take a first logic value (1, for example) in case of a NO SPARK condition, or a second logic value (0, for example) in case of a SPARK condition.

According to the example, the decision module 93 implements logic such that it increments (by one unit) a count value of the incrementable register 92 when the further comparing signal S_{DS} indicates the presence of a consecutive number of NO SPARK conditions equal to the above-mentioned number Ns. In addition, the decision module 93 implements logic such that it resets the count value of the incrementable register 92 each time the further comparing signal S_{DS} indicates the detection of a SPARK condition. The number Ns can be also equal to 1, and he count value is incremented by a single detection of a NO SPARK condition.

The incrementable register 92 is configured to store the count value CNᵢ, and generate the detecting signal SV_{ctrl}. According to this example, the detecting signal SV_{ctrl} can take a plurality of digital values corresponding to the present content of the incrementable register 92. For example, the incrementable register 92 (and the detecting signal SV_{ctrl}) can take a plurality of count values CN=[0, 1, 2, . . . , Nc]. A first count value CN₁ (0, for example) is representative of a SPARK condition. Each of the following values is indicative of the repetition of a NO SPARK condition for a number of times equal to the product Ns*CNᵢ.

The control apparatus 500 also comprises a driving module 300 connected to the control terminal Gₜ of the switch 4. The driving module 300 is configured to generate a first driving signal S_{ctrl} for the switch 4 dependent on the detecting signal SV_{ctrl}.

More specifically, the first driving signal S_{ctrl} is such to modify the switch 4 operating modes when the detecting module 9 detects an electrical absence or misfiring of the spark plug 3, or detects a plurality of consecutive electrical absences or misfirings of the electrical spark plug 3 following different engine ignition attempts.

More specifically, and with reference to the particular embodiment of FIG. 1, the driving module 300 comprises a voltage generation module 8 and a driving module and a current limiter 6. The voltage generation module 8 is configured to supply to a reference terminal 62 a reference signal, particularly a reference voltage V_{ref}, having a value dependent on the detecting signal SV_{ctrl}.

The voltage generation module 8 is, for example, a reference voltage generator and may be called a voltage reference. The voltage generation module 8 is of a known type, and generates electrical voltages having a substantially constant value as the load varies, as supply voltage fluctuations vary, and as the temperature varies.

According to the described example, the reference voltage V_{ref} can take a number of different values based on the indicated value of the detecting signal SV_{ctrl} applied at the input of the voltage generation module 8. The voltage generator 8 is configured so that the reference voltage V_{ref} decreases when the detecting signal SV_{ctrl} indicates an increment of the count value CN.

Increasing values CN=[0, 1, 2, . . . , Nc] taken by the detecting signal SV_{ctrl} (in other words by count values) correspond to respective decreasing values of the reference voltage V_{ref}=[V_{refM}, V_{ref1}, V_{ref2}, . . . , V_{refm}] where V_{refM} is a maximum value and V_{refm} is a minimum value. Therefore, the voltage generator 8 operates also as a digital-analog converter capable of converting digital information associated to the detecting signal SV_{ctrl} in an analog voltage that is in the reference voltage V_{ref}.

The current limiting module 6 (referred to simply as a limiting module) is configured to generate the first driving signal S_{ctrl} to the drive switch 4. The control current flows through the primary winding 10 based on the reference signal V_{ref}, a measuring voltage Vₛₑₙₛₑ, and based on the driving command CMD.

It is observed that the minimum value V_{refm}/supplied by the voltage generator 8, is selected so that for a reference voltage V_{refm} equal to the minimum value V_{refm}, the first driving signal S_{ctrl} ensures that in the closing state of the switch 4 there is a collector current I_{hvc} sufficient to charge the primary winding 10 with energy suitable to generate a spark in the spark plug 3.

Further, the maximum vale V_{refM} is selected so that at a reference voltage V_{ref} equal to a maximum vale V_{refM}, the first driving signal S_{ctrl} ensures that in the switch 4 closing state there is a collector current I_{hvc} having a predetermined nominal value. The limiting module 6 is provided with a control terminal 61 connected to the gate terminal Gₜ of the switch 4, and is adapted to supply the first driving signal S_{ctrl} to a command terminal 64 for the command signal CMD and with a sensing terminal 63 for the measuring voltage Vₛₑₙₛₑ.

The limiting module 6 is configured to compare the measuring voltage Vₛₑₙₛₑ, representative of the voltage at emitter terminal Eₜ, and therefore, also of the voltage at the collector terminal Cₜ of the switch 4, with the particular value taken by the reference voltage V_{ref}. The limiting module 6 generate the first driving signal S_{ctrl}. The first driving signal S_{ctrl} is such to cause the switch 4 to operate in a linear area so that the collector current I_{hvc} is limited. Under these conditions, the measuring voltage Vₛₑₙₛₑ is regulated so that it is equal to the reference voltage V_{ref} value.

The limiting module 6 can be implemented by an electronic circuit comprising a current generator for driving the gate terminal Gₜ of the switch 4 and a current limiting circuit. The current limiting circuit is, for example, of a conventional type.

The control apparatus 500 further comprises a voltage sensing module 7 configured to measure the voltage drop across the sensing resistor 5 and supply this measurement by a corresponding measurement signal, such as the measuring voltage Vₛₑₙₛₑ. The sensing resistor 5 is connected across the emitter terminal Eₜ of the switch 4, and the ground terminal gnd.

The voltage sensing module 7 is provided with a first sensing terminal 71 and a second sensing terminal 72 connected to the first and second terminals of the sensing resistor 5, respectively, and with a measurement terminal 73 adapted to supply the measuring voltage Vₛₑₙₛₑ. An additional Zener diode DZ1 has its anode connected to the gate terminal Gₜ of the switch 4, and its cathode connected to the collector terminal Cₜ of the switch 4 to limit the collector voltage V_{hvc} to avoid the breakdown phenomenon in the switch 4.

The control module 100, which is external the electronic ignition device 1000 and may be a microcontroller, for example, is configured to generate the command signal CMD. The command signal CMD commands the switch 4 between closing and opening states.

In the following, an example of operation of the electronic ignition system 1000, and therefore also of the control apparatus 500, will be provided. The control module 100 generates the command signal CMD as a square-shaped wave, for example. The time interval Tₒₙ, in which the signal keeps a high value, is for example, equal to 4 ms. The time interval T_{off}, in which the signal keeps a low value, is for example, equal to 16 ms. The value of a period of the square wave T is equal to 20 ms, and the duty cycle value is equal to 20%.

The present description of the electronic ignition system 1000 operation relates to a generic portion of the command signal CMD which refers to four ignition cycles 1, 2, 3, 4. Between two following leading edges of the command signal CMD there is an ignition cycle or an attempted engine ignition, and therefore, a closure and the following opening of the switch 4.

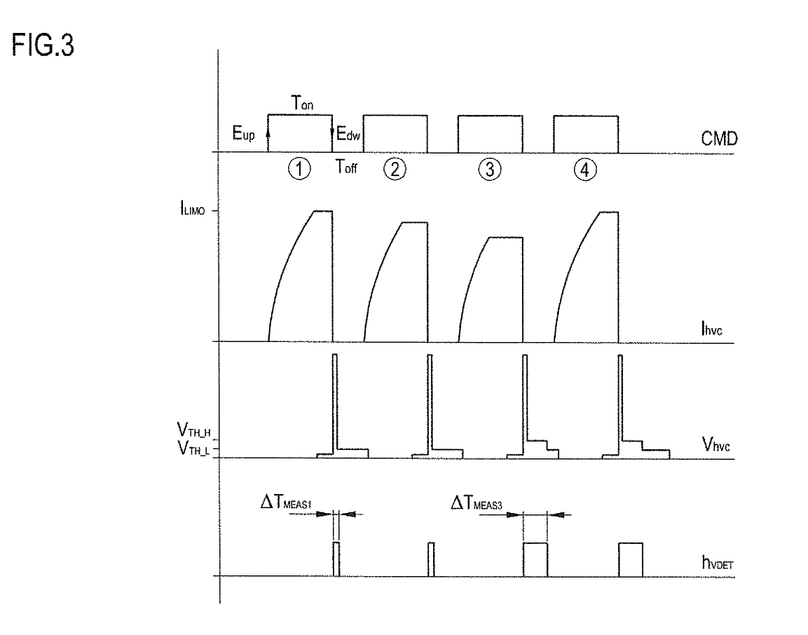

A first leading edge Eᵤₚ of the command signal CMD causes the limiting module 6 to close the switch 4. That is, according to the example, determines the switching on of the IGBT transistor. The IGBT transistor 4 switching on determines the start of the collector current I_{hvc} flow. Then, at the leading edge Eᵤₚ, the command signal CMD is kept at a high level for a time interval duration Tₒₙ which causes an increasing trend of the collector current I_{hvc}, as shown in FIG. 3.

During the interval Tₒₙ, the collector current I_{hvc} flows through the emitter terminal Eₜ of the switch 4, and from it, flows in the sensing resistor 5 by causing a voltage drop across its terminals. The voltage drop across the sensing terminal 5, having resistance Rₛₑₙₛₑ, is measured by the voltage sensing module 7 which therefore supplies the corresponding measuring voltage Vₛₑₙₛₑ in the limiting module 6.

The limiting module 6 compares the reference voltage V_{ref} with the measuring voltage Vₛₑₙₛₑ, which has an increasing trend proportional to the collector current I_{hvc} flowing in the sensing resistor 5 according to Vₛₑₙₛₑ=Rₛₑₙₛₑ*I_{hvc}. When the measuring voltage Vₛₑₙₛₑ is greater than a threshold value suitably less than the reference voltage V_{ref}, the limiting module 6 adjusts the voltage at the gate terminal Gₜ of the switch 4 to limit the intensity of the collector current I_{hvc} to a nominal current limiting value I_{LIM0}.

During the interval Tₒₙ, the collector current I_{hvc}, except for contribution of the current Iₕᵥ supplying the voltage detecting module 40, flows through the primary winding 10. The collector current I_{hvc} charges it to an energy value equal to L I²_{hvc}/2, where L is the inductance value of the primary winding 10.

At the end of the interval Tₒₙ, when the collector current I_{hvc} has already taken a nominal limiting value I_{LIM0}, the collector voltage V_{hvc} of the switch 4 is equal to the battery voltage V_{batt}.

At the trailing edge E_{dw}, the control signal CMD causes the limiting module 6 to open the switch 4 so that it determines the IGBT transistor switching off. Since the switch 4 has been opened, the collector voltage V_{hvc} rapidly increases, as shown in FIG. 3. The increment of the collector voltage V_{hvc} value at the collector terminal can possibly be limited by the action of the additional Zener diode DZ1 to avoid the break-down phenomenon in the switch 4.

The peak value of the collector voltage V_{hvc} during the opening of the switch 4 is, for example, between 300 V and 400V. It is observed that the collector voltage V_{hvc}, except for the battery voltage V_{batt}, corresponds to the voltage in the primary winding 10. Due to the inductive coupling between the primary winding 10 and the secondary winding 20, a voltage is generated in the secondary winding 20 having a value determined by the turns ratio of the electrical transformer 1. For example, assuming a turns ratio equal to 100, and a primary winding 10 voltage between 300 V and 400 V, the voltage arising in the secondary winding 20 is between 30 kV and 40 kV.

In the presence of the spark plug 3 and of its correct operation, the voltage generated in the secondary winding 20 is applied to the central electrode of the spark plug 3 so that a spark is generated inside the combustion chamber. Therefore, the energy stored in the primary winding 10 is released to the secondary winding 20. This operating condition is indicated, as stated above, as the SPARK condition.

Instead, in case of an absence of the spark plug 3 absence, or a malfunction of the same, the spark is not generated inside the combustion chamber. Consequently, the energy stored in the primary winding 10 is not released to the secondary winding 20. As a consequence of this operating condition, a NO SPARK condition is present. The energy stored in the primary winding will be dissipated by the switch 4 according to the modes that will be described in the following paragraphs.

One case is during cycle 1, as in FIG. 3, where a NO SPARK condition exists. At the trailing edge E_{down} of the command signal CMD, the comparing module 30 compares the reading signal Vᵣₕᵥ, representative of the collector voltage V_{hvc}, supplied by the detecting module 40, with the first threshold voltage VTH_H delivered by the selection module.

The value of the first threshold voltage VTH_H is set so that at the opening of the switch 4, the reading signal Vᵣₕᵥ exceeds the value of the first threshold voltage VTH_H. Until the reading signal Vᵣₕᵥ is less than the first threshold voltage VTH_H value, the comparing signal hv_{DET} takes a first logic value, 0 for example.

The reading signal Vᵣₕᵥ follows the trend of the collector voltage V_{hvc} occurring from the instant in which the switch 4 is opened. The collector voltage V_{hvc} has a peak and rapidly decreases due to the dissipation occurring in the switch 4 if the latter is in an open state.

From the instant at which the reading signal Vᵣₕᵥ exceeds, by increasing, the first threshold voltage VTH_H value, the comparing signal hv_{DET} switches to a second logic value, 1 for example. It is noted that under both a SPARK condition and a NO SPARK condition, the comparing signal hv_{DET} will not further switch and, therefore, it will keep the logic value 1 until a substantially complete dissipation of the energy stored in the primary winding 10 occurs.

The comparing signal hv_{DET} switching, from logic value 0 to logic value 1, causes the selection module 32 to switch and supply to the comparator 31 the second threshold voltage VTH_L, whose expected value is less than the first threshold voltage VTH_H. Moreover, the comparing signal hv_{DET}, by switching from logic value 0 to logic value 1, activates a process of the measuring time duration Δt_{MEAS} between two following edges of the comparing signal hv_{DET} performed by the time detecting module 13.

Until the reading signal \Iᵣₕᵥ remains above the second threshold voltage VTH_L, the comparing signal hv_{DET} remains equal to the logic value 1. Then, when the reading signal Vᵣₕᵥ decreases below the second threshold voltage VTH_L, the comparing signal hv_{DET} switches to the logic value 0. This occurs when the collector voltage V_{hvc} decreases due to the dissipation in the switch 4.

When the comparing signal hv_{DET} switches from the logic value 1 to the logic value 0, the time detecting module 13 passes through the process of measuring the time duration Δt_{MEAS} between two following edges of the comparing signal hv_{DET}. This makes available the measured value Δt_{MEAS1} in the detecting module 9.

The comparing digital module 91 of the detecting module 9 receives at its input the measured time duration Δt_{MEAS1} value and compares it with the time threshold Tₜₕ suitably selected. This is to discriminate between two possible operating conditions, the SPARK condition or NO SPARK condition.

To this end, a time interval t_{HV} is defined as the time interval wherein the collector voltage V_{hvc} remains below the second threshold voltage VTH_L. For the SPARK conditions, the time interval takes value t_{HV}(SPARK), which is greater than the value t_{HV}(NO SPARK), which is the case for a NO SPARK condition:

t_{HV}(SPARK)>t_{HV}(NO SPARK)

Typically, but not in a limiting way, the value t_{HV}(SPARK) is between 0.8 ms and 2 ms, and the value t_{HV}(NO SPARK) is not greater than 0.3 ms. According to this example, the above mentioned threshold time Tₜₕ can be selected in the range from 0.3 to 0.8 (0.5 msec, for example).

Referring to cycle 1 in FIG. 3, the measured time duration Δt_{MEAS1} is less than the time threshold Tₜₕ, and therefore, the time comparing module 91 detects a NO SPARK operating condition, and generates an additional comparing signal S_{DS}. The additional comparing signal S_{DS} takes, for example, a first logic value 1. The additional comparing signal S_{DS} is made available to the decision module 93. Moreover, it is considered that for the particular case where Ns is equal to 1, and the incrementable register 92 is incremented by one unit for each single detection of a NO SPARK condition.

Therefore, due to this logic value 1, taken by the additional comparing signal S_{DS}, the decision module 93 increments one unit the content of the incrementable register 92, and consequently, the digital value represented by the detecting signal SV_{ctrl} is incremented.

The value of the incrementable register 92, as determined this way, is made available to the voltage generating module 8 by an update of the value taken by the detecting signal SV_{ctrl} based on the new count value taken by the incrementable register 92.

On the basis of the value taken by the detecting signal SV_{ctrl}, the voltage generation module 8 generates a new value V_{ref1} of the reference voltage V_{ref}. The new value V_{ref1} of the reference voltage V_{ref} is less than the value of the reference voltage V_{ref} previously taken.

In this way, in the following cycle 2 of the ignition and opening of the switch 4, the limiting module 6 generates the second driving signal S_{ctrl} having a value so that the collector current I_{hvc} will have a maximum value reduced with respect to the one occurring in the previous cycle.

Moreover, as it is apparent from FIG. 3, both the reference voltage and a maximum value of the collector current I_{hvc} decreases (within predetermined ranges) in cycle 2 with respect to cycle 1. According to the shown example, also in cycle 2, a NO SPARK condition occurs with a further reduction of the maximum collector current I_{hvc} (a limiting current) in following cycle 3.

It is observed that in these consecutive NO SPARK conditions, reducing the maximum current in the switch 4 in an open condition decreases the energy dissipated in the switch 4, and consequently, reduces the stress applied to it in case of an anomaly in the spark plug 3 operation.

According to the example shown in FIG. 3, in cycle 3 it is verified that the time duration Δt_{MEAS3} is higher than or equal to the time threshold value Tₜₕ, and therefore, the detecting module 9 detects a SPARK operating condition and resets the count value stored in the incrementable register 92.

The reset value of the incrementable register 92 is made available to the voltage generating module 8 by a further update of the value taken by the detecting signal SV_{ctrl}. On the basis of the value taken by the updated detecting signal SV_{ctrl}, the voltage generating module 8 generates the reference voltage V_{ref} having value Vₘₐₓ. Therefore, in the following ignition cycle, that is cycle 4, the collector current I_{hvc} could take the predetermined maximum nominal value. This exemplifying situation shown by cycles 1, 2, 3 and 4 in FIG. 3 can occur, for example, when the spark plug is fouled, and therefore, it can happen that after a certain number of unsuccessful attempts, at last a spark strikes.

It is observed that, according to a further embodiment, it is possible to consider a case wherein the switch 4 is prevented from closing after the occurrence of a predetermined number of consecutive NO SPARK conditions (Ns being greater than or equal to 1). For example, an additional counter is provided to count the number of times a number of NO SPARK conditions equal to Ns is detected. Further, in this case, the command module 100 can prevent additional cycles of switching on and off the switch 4. This approach enables prevention of the switch 4 from breaking down.

The electronic ignition has a very important function for the safety of a vehicle since a switch 4 breakdown, besides preventing a cylinder from operating, could also cause also serious breakdowns. In some cases, a fire or serious damages to the coil or central unit could occur.

A thermal model of an IGBT has been implemented to test its performance in case of a failed spark, and for a collector current trend analogous to the one obtained in the described ignition system 1000. One is also obtained according to the prior art without a limiting current reduction as the number of no-spark cycles increases.

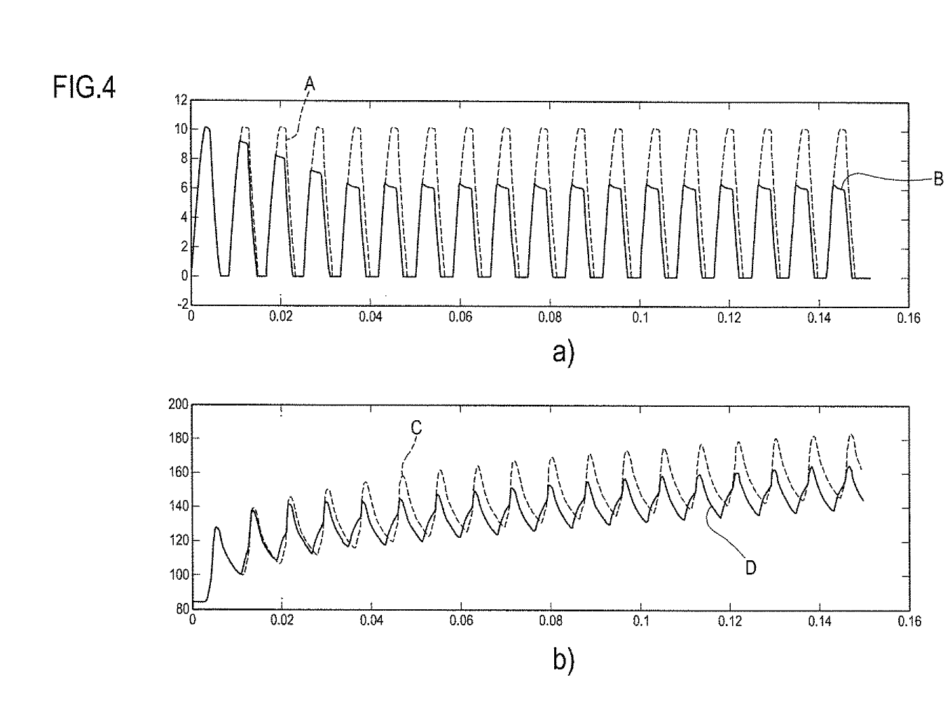

More specifically, FIG. 4a shows a first curve A of the collector current trend for several ignition cycles in an open secondary. This may always be an active limiting current condition. FIG. 4b shows a second curve B of the collector current I_{hvc} trend for several ignition cycles, as it occurs in the described ignition system 1000. Curve A shows the absence of a reduction of the limiting current which appears instead in curve B.

In FIG. 4d, a third curve C and a fourth curve D refer to a trend as a function of the time and a junction temperature of an IGBT 4 for the collector currents having the trend of curves A and B, respectively. By observing curves C and D, it is noted that within about 150 ms the junction temperature reached by the IGBT 4 for a collector current following the trend of the second curve B is about 20° C. less than the one reached by an IGBT supplied by a current having the trend of first curve A.

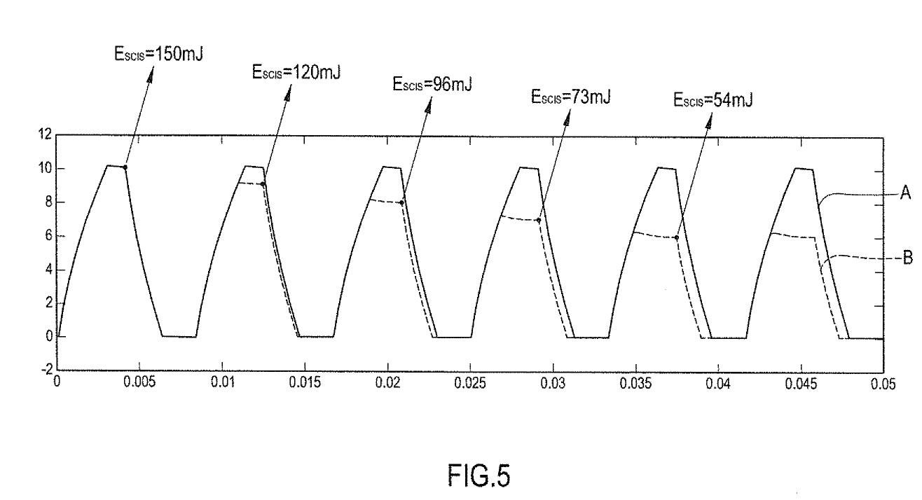

Moreover, FIG. 5 shows again the first curve A and the second curve B, and in addition, indicates for each different value of a limiting current of the two above-mentioned curves, where the corresponding electrical energy E_{SCIS} to be dissipated. As it will be appreciated from FIG. 5, in the considered example, the minimum value of the limiting current entails an energy to be dissipated equal to 54 mJ. In other words, a value about three times less than the one to be dissipated for a limiting maximum current value equal to 150 mJ.

The above mentioned ignition system 1000 and control apparatus 500 have several advantages in comparison with the prior art systems. Particularly, a reduction of the maximum temperature reached by the junction of the solid-state switch and a reduction of the electrical energy to be dissipated in operating anomalies in the spark plug. This allows the life of a solid-state switch to be extended, and also enables smaller size (less expensive) and faster solid-state switches providing the same performance, despite the smaller switches being less efficient from a heat dissipation point of view.

1-14. (canceled)

15. A control apparatus for an engine ignition spark plug comprising:
a switch comprising a control terminal and an output terminal both to be connected to an external transformer, said switch having a closed state to supply a voltage to the transformer and an open state to release the voltage from the transformer to the spark plug;
a measuring module configured to measure in the open state a time duration of a voltage at the output terminal decreasing from a first value to a second value; and
a detecting module configured to detect an operating condition of the spark plug based on comparing the measured time duration to a time threshold, and to generate a detecting signal based on the comparing.

16. The control apparatus according to claim 15, further comprising a driving module connected to the control terminal and configured to generate a driving signal for said switch based on the detecting signal.

17. The control apparatus according to claim 16, wherein said detecting module detects a first anomaly condition corresponding to a failed electrical spark of the spark plug, and a second anomaly condition corresponding to more than one failed electrical spark of the spark plug, with the driving signal modifying an operating mode of said switch based on detecting the first and second anomaly conditions.

18. The control apparatus according to claim 15, wherein said measuring module comprises:
a measuring sensor connected to said output terminal and configured to generate a reading voltage; and
a comparing module configured to compare a supply voltage coupled to the external transformer with the reading voltage, and to generate a first comparing signal based on the comparing.

19. The control apparatus according to claim 18, wherein said measuring module further comprises a time detecting module configured to generate a time duration value corresponding to a time duration of the first comparing signal.

20. The control apparatus (500) according to claim 19, wherein said detecting module comprises a time comparing module configured to compare the time duration value with the time threshold, and to generate a second comparing signal having
a first value representative of a failed spark of the spark plug if the time duration value is less than the time threshold; and
a second value representative of a successful spark of the spark plug if the time duration value is greater than the time threshold.

21. The control apparatus according to claim 20, wherein said detecting module further comprises a register configured to increment a count value therein when the second comparing signal takes a value that is one or more times the first value, and provides the detecting signal based on the count value.

22. The control apparatus according to claim 21, wherein said driving module comprises:
a reference voltage generator configured to receive the detecting signal and generate a corresponding electrical reference voltage; and
an electrical current limiting circuit configured to generate the driving signal as a function of the reference electrical voltage, and to adjustment an electrical current at the output terminal of said switch.

23. The control apparatus according to claim 22, wherein said detecting module and said reference voltage generator are configured so that the reference electrical voltage decreases when the detecting signal indicates an increment of the count value.

24. The control apparatus according to claim 23, wherein said detecting module is configured so that the reference electrical voltage takes a value between a minimum voltage value that is greater than a minimum voltage necessary for generating a spark in the spark plug, and a maximum voltage value corresponding to a predetermined electrical current at the collector terminal.

25. The control apparatus according to claim 23, further comprising an electrical voltage sensing device comprising:
at least one first terminal connected to an additional output terminal of said switch for receiving a voltage;
a second terminal for providing to the current limiting circuit a detected voltage indicating the voltage being drawn; and
said current limiting circuit being configured to compare the reference voltage with the detected voltage, and to generate the corresponding driving signal for the switch.

26. The control apparatus according to claim 15, wherein said switch comprises at least one of a Darlington transistor, a three-stage transistor, and an IGBT transistor.

27. An electronic ignition system for an internal combustion engine comprising:
a spark plug;
a transformer having a primary winding, and a secondary winding connected to said spark plug; and
a control apparatus connected to the primary winding and comprising
a switch comprising a control terminal and an output terminal both connected to the primary winding of said a transformer, said switch having a closed state to supply a voltage to said transformer and an open state to release the voltage from said transformer to said spark plug,
a measuring module configured to measure in the open state a time duration of a voltage at the output terminal decreasing from a first value to a second value, and
a detecting module configured to detect an operating condition of said spark plug based on comparing the measured time duration to a time threshold, and to generate a detecting signal based on the comparing.

28. The electronic ignition system according to claim 27, further comprising a control module coupled to said control apparatus to control ignition timing of said spark plug.

29. The electronic ignition system according to claim 27, wherein said control apparatus further comprises a driving module connected to the control terminal and configured to generate a driving signal for said switch based on the detecting signal, said detecting module detecting a first anomaly condition corresponding to a failed electrical spark of said spark plug, and a second anomaly condition corresponding to more than one failed electrical spark of said spark plug, with the driving signal modifying an operating mode of said switch based on detecting the first and second anomaly conditions.

30. The electronic ignition system according to claim 27, wherein said measuring module comprises:
a measuring sensor connected to said output terminal and configured to generate a reading voltage;
a comparing module configured to compare a supply voltage coupled to the external transformer with the reading voltage, and to generate a first comparing signal based on the comparing; and
a time detecting module configured to generate a time duration value corresponding to a time duration of the first comparing signal.

31. The electronic ignition system according to claim 30, wherein said detecting module comprises:
a time comparing module configured to compare the time duration value with the time threshold, and to generate a second comparing signal having a first value representative of a failed spark of said spark plug if the time duration value is less than the time threshold, and a second value representative of a successful spark of said park plug if the time duration value is greater than the time threshold; and
a register configured to increment a count value therein when the second comparing signal takes a value that is one or more times the first value, and provides the detecting signal based on the count value.

32. The electronic ignition system according to claim 31, wherein said driving module comprises:
a reference voltage generator configured to receive the detecting signal and generate a corresponding electrical reference voltage; and
an electrical current limiting circuit configured to generate the driving signal as a function of the reference electrical voltage, and to adjustment an electrical current at the output terminal of said switch.

33. A method for operating a control apparatus for an engine ignition spark plug, the control apparatus comprising a switch comprising a control terminal and an output terminal both connected to a transformer, the method comprising:
operating the switch in a closed state to supply a voltage to the transformer and in an open state to release the voltage from the transformer to the spark plug;
measuring in the open state a time duration of a voltage at the output terminal decreasing from a first value to a second value; and
detecting an operating condition of the spark plug based on comparing the measured time duration to a time threshold; and
generating a detecting signal based on the comparing.

34. The method according to claim 33, further comprising generating a driving signal for the switch based on the detecting signal; and wherein the detecting comprises detecting a first anomaly condition corresponding to a failed electrical spark of the spark plug, and a second anomaly condition corresponding to more than one failed electrical spark of the spark plug, with the driving signal modifying an operating mode of the switch based on detecting the first and second anomaly conditions.

35. The method according to claim 34, wherein the control apparatus comprises a measuring module performing the measuring, the measuring module comprising:
a measuring sensor connected to the output terminal and configured to generate a reading voltage, and
a comparing module configured to compare a supply voltage coupled to the external transformer with the reading voltage, and to generate a first comparing signal based on the comparing; and
a time detecting module configured to generate a time duration value corresponding to a time duration of the first comparing signal.

36. The method according to claim 35, wherein the control apparatus comprises a detecting module performing the detecting and generating, the detecting module comprising:
a time comparing module configured to compare the time duration value with the time threshold, and to generate a second comparing signal having a first value representative of a failed spark of the spark plug if the time duration value is less than the time threshold, and a second value representative of a successful spark of the park plug if the time duration value is greater than the time threshold; and
a register configured to increment a count value therein when the second comparing signal takes a value that is one or more times the first value, and provides the detecting signal based on the count value.

37. The method according to claim 36, wherein the control apparatus comprises a driving module generating the driving signal, the driving module comprising:
a reference voltage generator configured to receive the detecting signal and generate a corresponding electrical reference voltage; and
an electrical current limiting circuit configured to generate the driving signal as a function of the reference electrical voltage, and to adjustment an electrical current at the output terminal of the switch.
